(19) United States
(12) Patent Application Publication
(10) Pub. No.: US 2025/0279669 A1
(43) Pub. Date: Sep. 4, 2025

(54) CHARGE CONTROL APPARATUS AND CHARGE CONTROL METHOD

(71) Applicant: HONDA MOTOR CO., LTD., Tokyo (JP)

(72) Inventors: Kosuke Murata, Tokyo (JP); Naoya Hayashida, Tokyo (JP); Yoichi Asano, Tokyo (JP); Toru Nakanishi, Tokyo (JP); Satoshi Sekiguchi, Tokyo (JP); Tatsuki Serizawa, Tokyo (JP); Yukikazu Fukumoto, Tokyo (JP); Tetsuhiro Chiba, Tokyo (JP); Fuminori Fujino, Tokyo (JP)

(21) Appl. No.: 19/016,372

(22) Filed: Jan. 10, 2025

(30) Foreign Application Priority Data
Mar. 1, 2024 (JP) 2024-031375

(51) Int. Cl. H02J 7/14; B60R 16/033; H02J 7/00

(52) U.S. Cl. CPC H02J 7/1446; B60R 16/033; H02J 7/007194

(57) ABSTRACT

A charge control apparatus is mounted on a vehicle having a secondary battery charged with output electric power of a generator driven by an engine, and includes: an engine operation time measurement unit measuring an operation time of the engine during a use period; an initial charge amount setting unit setting an initial charge amount based on a previous engine operation time, the initial charge amount being for supplementing, in use start of the vehicle, an amount of decrease of a power storage amount of the secondary battery from previous use end of the vehicle, the previous engine operation time being an operation time of the engine measured by the engine operation time measurement unit during a previous use period of the vehicle; and a charge control unit performing initial charge control of charging the secondary battery by the initial charge amount in use start of the vehicle.

### INCORPORATION BY REFERENCE

The present application claims priority under 35 U.S.C. § 119 to Japanese Patent Application No. 2024-031375 filed on Mar. 1, 2024. The content of the application is incorporated herein by reference in its entirety.

### BACKGROUND OF THE INVENTION

### Field of the Invention

The present invention relates to a charge control apparatus and a charge control method.

### Description of the Related Art

Research and development related to secondary batteries which contribute to efficient use of energy are being conducted in recent years in order to make it possible to secure access of more people to reasonable, reliable, sustainable, and advanced energy. For example, Japanese Patent No. 4959511 (which is hereinafter referred to as Patent Literature 1) discloses a charge control apparatus that increases more a target charge amount of a storage battery set at engine start as an elapsed time from the time point of the storage battery being mounted on a vehicle is longer.

### SUMMARY OF THE INVENTION

Now, in a technology related to a secondary battery, it is needed to set a charge amount of the secondary battery appropriately in use start of a vehicle in accordance with the amount of decrease of a power storage amount of the secondary battery due to self-discharge and/or dark current during the vehicle not being used. With the configuration disclosed in Patent Literature 1 above, while the charge amount can be set in consideration of deterioration of the secondary battery over time, the amount of decrease of the power storage amount of the secondary battery varies depending on use situations of the vehicle. Therefore, the case of the configuration disclosed in Patent Literature 1 can problematically cause overcharge of the secondary battery in use start of the vehicle to accelerate deterioration of the secondary battery.

In order to solve the aforementioned problem, an object of the present application is to restrain deterioration of a secondary battery due to overcharge by appropriately setting a charge amount of the secondary battery in use start of a vehicle. This also contributes to efficient use of energy.

There is provided a charge control apparatus as a first aspect for achieving the aforementioned object, the charge control apparatus being mounted on a vehicle, the vehicle having an engine, a generator driven by the engine, and a secondary battery that is charged by the generator, the charge control apparatus controlling charge of the secondary battery by the generator, the charge control apparatus including: an engine operation time measurement unit that measures an operation time of the engine during a use period from use start to use end of the vehicle; an initial charge amount setting unit that sets an initial charge amount based on a previous engine operation time, the initial charge amount being for supplementing, in use start of the vehicle, an amount of decrease of a power storage amount of the secondary battery from previous use end of the vehicle, the previous engine operation time being an operation time of the engine measured by the engine operation time measurement unit during a previous use period of the vehicle; and a charge control unit that performs initial charge control of charging the secondary battery by the initial charge amount in use start of the vehicle.

In the aforementioned charge control apparatus, there may be employed a configuration in which the initial charge amount setting unit decreases the initial charge amount more as the previous engine operation time is longer.

In the aforementioned charge control apparatus, there may be employed a configuration in which the initial charge amount setting unit sets the initial charge amount to a first initial charge amount when the previous engine operation time is shorter than a first threshold, and sets the initial charge amount to a second initial charge amount smaller than the first initial charge amount when the previous engine operation time is not less than a second threshold longer than the first threshold.

In the aforementioned charge control apparatus, there may be employed a configuration in which, when the previous engine operation time is between the first threshold and the second threshold, the initial charge amount setting unit gradually decreases the initial charge amount from the first initial charge amount to the second initial charge amount as the previous engine operation time becomes longer.

In the aforementioned charge control apparatus, there may be employed a configuration in which a secondary battery temperature recognition unit that recognizes a temperature of the secondary battery is included, wherein the initial charge amount setting unit sets the initial charge amount in accordance with the temperature, of the secondary battery, that is recognized by the secondary battery temperature recognition unit when use of the vehicle is started.

In the aforementioned charge control apparatus, there may be employed a configuration in which the charge control unit forcibly ends the initial charge control when the initial charge control is not completed until a predetermined time elapses from start of the initial charge control.

In the aforementioned charge control apparatus, there may be employed a configuration in which the predetermined time is a fixed time regardless of the previous engine operation time.

There is provided a charge control method as a second aspect for achieving the aforementioned object, the charge control method being performed by a charge control apparatus that is mounted on a vehicle, the vehicle having an engine, a generator driven by the engine, and a secondary battery that is charged by the generator, the charge control apparatus controlling charge of the secondary battery by the generator, the charge control method including: an engine operation time measurement step of measuring an operation time of the engine during a period from use start to use end of the vehicle; an initial charge amount setting step of setting an initial charge amount based on a previous engine operation time, the initial charge amount being for supplementing, in use start of the vehicle, an amount of decrease of a power storage amount of the secondary battery from a previous use end time point of the vehicle, the previous engine operation time being an operation time of the engine measured by the engine operation time measurement step during a previous use period of the vehicle; and a charge control step of performing initial charge control of charging the secondary battery by the initial charge amount in use start of the vehicle.

According to the aforementioned charge control apparatus and charge control method, the charge amount of the secondary battery in use start of the vehicle can be appropriately set, and deterioration of the secondary battery due to overcharge can be restrained.

### BRIEF DESCRIPTION OF THE DRAWINGS

FIG. 1 is a configuration diagram of a vehicle that a charge control apparatus is mounted on;

FIG. 2 is an explanatory diagram of a first map for setting an initial charge amount;

FIG. 3 is an explanatory diagram of a second map for setting the initial charge amount;

FIG. 4 is a flowchart of processing related to initial charge of a battery;

FIG. 5 is an explanatory diagram of a first technology related to the present disclosure;

FIG. 6 is an explanatory diagram of a second technology related to the present disclosure; and

FIG. 7 is an explanatory diagram of a third technology related to the present disclosure.

### DETAILED DESCRIPTION OF THE INVENTION

### 1. Configuration of Charge Control Apparatus

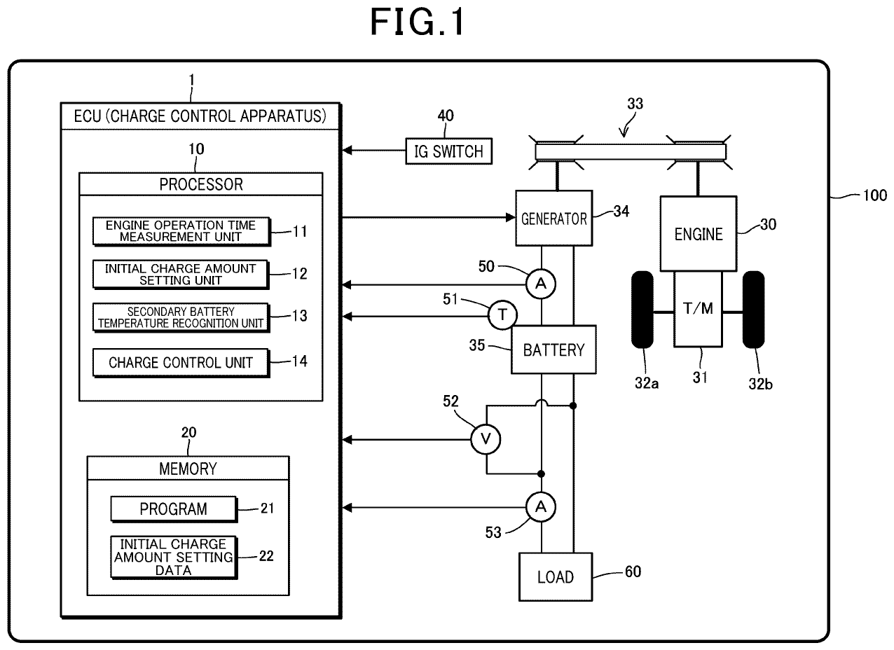

A configuration of a charge control apparatus of the present embodiment will be described with reference to FIG. 1. The charge control apparatus of the present embodiment is configured as a part of functions of an ECU (Electronic Control Unit) 1 mounted on a vehicle 100.

The vehicle 100 includes an engine 30 that is a motive power source of the vehicle 100 and drives driving wheels 32a and 32b, a generator 34 that generates electric power by being rotated with a driving force transmitted from the engine 30 via a driving force transmission unit 33, the generator 34 converting the generated AC electric power into DC electric power, the generator 34 outputting the resulting DC electric power, and a battery 35 that is charged with the DC electric power output from the generator 34. For example, the battery 35 is a lead storage battery and corresponds to a secondary battery of the present disclosure. The battery 35 may be another kind of secondary battery, such as a lithium ion battery.

DC electric power output from the battery 35 operates various loads 60 included in the vehicle 100. For example, the loads 60 are lamps, a compressor of an air conditioning apparatus, and the like. Furthermore, the vehicle 100 includes an IG switch 40 for performing operations of turning ON and OFF an ignition of the vehicle 100, a charging current sensor 50 that detects a current (charging current) supplied to the battery 35 from the generator 34, a temperature sensor 51 that detects a temperature of the battery 35, a voltage sensor 52 that detects an interterminal voltage of the battery 35, and an output current sensor 53 that detects a current output to the loads 60 from the battery 35.

The ECU 1 is connected to the IG switch 40, the charging current sensor 50, the temperature sensor 51, the voltage sensor 52, the output current sensor 53, and the generator 34. To the ECU 1, there are input an operation signal of the IG switch 40, and detection signals of the charging current sensor 50, the temperature sensor 51, the voltage sensor 52, and the output current sensor 53. Moreover, with a control signal output from the ECU 1, generated electric power of the generator 34 is controlled.

The ECU 1 is a control apparatus having a processor 10, a memory 20, a not-shown interface circuit, and the like. In the memory 20, there are stored a program 21 for control of the ECU 1, initial charge amount setting data 22 used for setting an initial charge amount mentioned later, and the like. By reading and executing the program 21, the processor 10 functions as an engine operation time measurement unit 11, an initial charge amount setting unit 12, a secondary battery temperature recognition unit 13, and a charge control unit 14.

Processing performed by the engine operation time measurement unit 11 corresponds to an engine operation time measurement step in a charge control method of the present disclosure, and processing performed by the initial charge amount setting unit 12 corresponds to an initial charge amount setting step in the charge control method of the present disclosure. Processing performed by the charge control unit 14 corresponds to a charge control step in the charge control method of the present disclosure.

The engine operation time measurement unit 11 measures an operation time of the engine 30 during a use period of the vehicle 100. The use period of the vehicle 100 is a period from an ON-operation of the IG switch 40 to an OFF-operation of the IG switch 40 by a user of the vehicle 100. Based on an engine operation time during a previous use period of the vehicle 100 measured by the engine operation time measurement unit 11, the initial charge amount setting unit 12 sets an initial charge amount that is a charge amount for supplementing an amount of decrease of a power storage amount of the battery 35 during a period when the vehicle 100 is not being used, the supplementing being performed in use start of the vehicle 100.

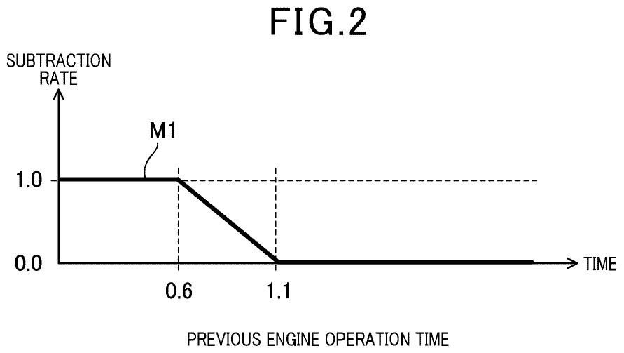

Based on a map M1 in which a subtraction rate shown in FIG. 2 is associated with an operation time (previous engine operation time) of the engine 30 during the previous use period of the vehicle 100, the initial charge amount setting unit 12 sets the initial charge amount when the vehicle 100 starts to be used. In the map M1 in FIG. 2, the subtraction rate is associated with the previous engine operation time, where the axis of ordinates is set to the subtraction rate relative to a reference amount of the initial charge amount, and the axis of abscissas is set to the previous engine operation time. The map M1 is created based on experimental data with this vehicle, computer simulation, and/or the like. The data of the association map M1 in FIG. 2 is included in the initial charge amount setting data 22.

In the map M1 in FIG. 2, the subtraction rate is 1.0 in a range of the previous engine operation time being from 0 hours to less than 0.6 hours, the subtraction rate gradually decreases in a range of the previous engine operation time being from 0.6 hours to 1.1 hours, and the subtraction rate is 1.1 in a range of the previous engine operation time being longer than 1.1. In FIG. 2, 0.6 hours corresponds to a first threshold of the present disclosure, and 1.1 hours corresponds to a second threshold of the present disclosure.

The initial charge amount setting unit 12 sets the initial charge amount based on equation (1) below.

Chi=Chb×Sr (1)

where Chi: initial charge amount, Chb: reference amount of the initial charge amount, and Sr: subtraction rate.

The initial charge amount in the range of the previous engine operation time being from 0 hours to less than 0.6 hours corresponds to a first initial charge amount of the present disclosure, and the initial charge amount in the range of the engine operation time being longer than 1.1 hours corresponds to a second initial charge amount of the present disclosure.

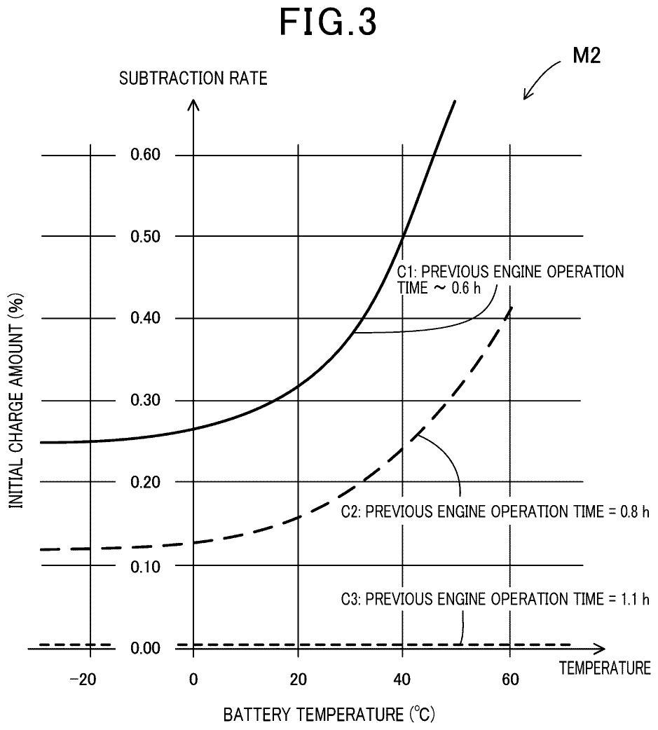

Based on a temperature detection signal of the temperature sensor 51, the secondary battery temperature recognition unit 13 recognizes the temperature of the battery 35. FIG. 3 shows a map M2 for determining the subtraction rate relative to the reference amount in consideration of the temperature of the battery 35 recognized by the secondary battery temperature recognition unit 13. The initial charge amount setting unit 12 may set the initial charge amount using the map M2 shown in FIG. 3.

With the map M2 in FIG. 3, there are exemplarily presented maps under three respective conditions of C1 corresponding to the range of the previous engine operation time being less than 0.6 hours, C2 corresponding to the time of the previous engine operation time being 0.8 hours, and C3 corresponding to the case of the engine operation time being 1.1 hours, where the axis of ordinates is set to the subtraction rate and the axis of abscissas is set to the temperature of the battery 35. The map M2 in FIG. 3 employs settings in which the initial charge amount becomes larger as the temperature of the battery 35 becomes higher in a range of the previous engine operation time being relatively short.

The charge control unit 14 performs initial charge control of controlling a power generation amount of the generator 34 to adjust the amount of the charging current supplied to the battery 35 and charging, in use start of the vehicle 100, the battery 35 by the initial charge amount set by the initial charge amount setting unit 12.

### 2. Initial Charge of Battery

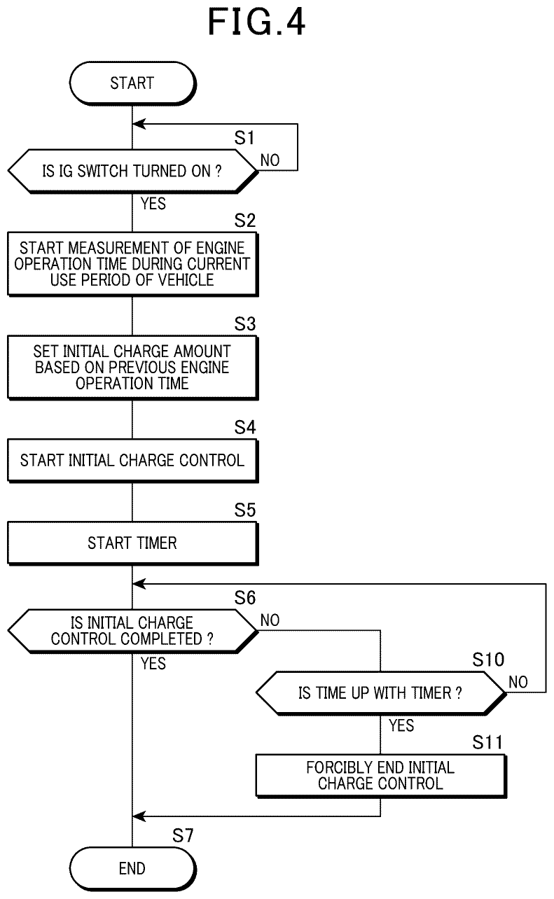

According to a flowchart shown in FIG. 4, processing related to initial charge of the battery 35 is described, the processing being performed by the ECU 1 in use start of the vehicle 100. In step S1 of FIG. 4, when the IG switch 40 is operated to be turned ON, the engine operation time measurement unit 11 puts the process forward to step S2 to start to measure an engine operation time during a current use period of the vehicle 100. As shown in FIG. 1, when the vehicle 100 is a gasoline-powered vehicle or a diesel vehicle, which only has an engine as a motive power source, the engine 30 starts in accordance with the ON-operation of the IG switch 40.

Subsequently in step S3, the initial charge amount setting unit 12 acquires the subtraction rate corresponding to the previous engine operation time using the aforementioned map shown in FIG. 2 or FIG. 3, and calculates the initial charge amount based on equation (1) above. Next in step S4, the charge control unit 14 starts the initial charge control. Subsequently in step S5, the charge control unit 14 starts a timer for monitoring an elapsed time from the start of the initial charge control. A set time for the timer corresponds to a predetermined time of the present disclosure. The set time for the timer may be a fixed time, or the set time for the timer may be set, according to the previous engine operation time, for example, to be longer as the previous engine operation time is longer.

Subsequently in loop processing of steps S6 and S10, the charge control unit 14 determines whether or not the initial charge control is completed in step S6 and determines whether or not time is up with the timer in step S10. When the initial charge control is completed in step S6, the process is put forward to step S7 to end the processing according to the flowchart in FIG. 4. Moreover, when time is up with the timer in step S10, the charge control unit 14 put the process forward to step S11 to end the initial charge control forcibly thereby to restrain overcharge of the battery 35 and to put the process forward to step S7.

### 3. Other Embodiments

While in the aforementioned embodiment, the vehicle 100, which only has the engine 30 as the motive power source and includes the generator 34 driven by the engine 30, is presented, a vehicle of the present disclosure may be a hybrid vehicle that has an engine and an electric motor as motive power sources and includes a generator driven by the engine.

While in the aforementioned embodiment, according to the processing of steps S10 and S11 in FIG. 4, there is performed the processing of forcibly ending the initial charge control when the elapsed time from the start of the initial charge control becomes not less than a predetermined time, there may be employed a configuration in which this processing is omitted.

Notably, FIG. 1 is a schematic diagram showing the charge control apparatus configured as a part of functions of the ECU 1, the charge control apparatus being segmented by principal processing contents for ease of understanding the invention as claimed in the present application, and the charge control apparatus may be configured based on other segmentations. Moreover, the processing of each constituent may be performed by one hardware unit or may be performed by a plurality of hardware units. Moreover, the processing by each constituent shown in FIG. 4 may be executed by one program or may be executed by a plurality of programs.

### 4. Technologies Related to the Present Disclosure

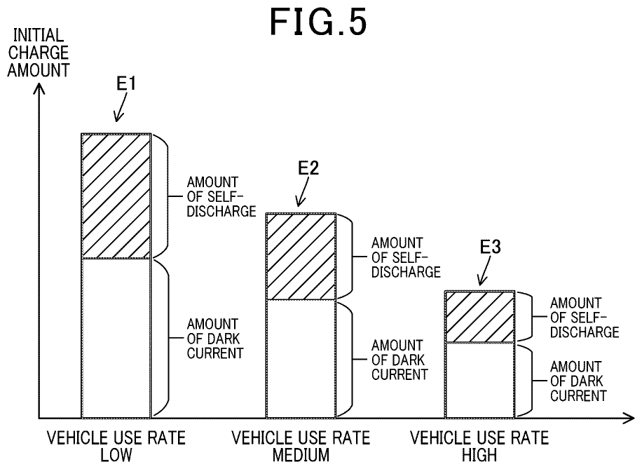

Technologies related to the present disclosure are described with reference to FIG. 5 to FIG. 7. First, FIG. 5 exemplarily shows a technique of setting the initial charge amount in accordance with a vehicle use rate which is a rate of the time when the vehicle 100 is being used during a predetermined monitoring period (for example, weeks). Using the operation time of the engine per day (engine operation time hr/day) as the vehicle use rate, FIG. 5 shows E1, the case where the vehicle use rate is low (for example, vehicle use rate<1.5 hr/day), E2, the case where the vehicle use rate is medium (for example, vehicle use rate=1.5 to 3 hr/day), and E3, the case where the vehicle use rate is high (for example, 3 hr/day<vehicle use rate).

Since a lower vehicle use rate causes a less power generation amount of the generator 34 with the driving force of the engine 30, it is inferred that this causes a more amount of decrease of the power storage amount of the battery due to the amount of self-discharge (natural discharge) of the battery 35 and the amount of dark current flowing through the loads 60 and the like. Therefore, as shown in FIG. 5, by setting the initial charge amount to be larger as the vehicle use rate is lower, an appropriate initial charge amount can be set while overcharge of the battery 35 is restrained.

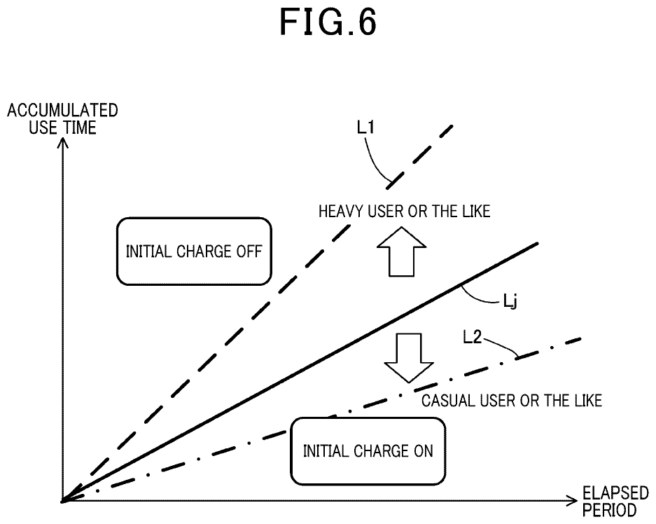

Next, FIG. 6 shows straight lines indicating increase of an accumulated use time of the vehicle 100 relative to an elapsed period (monitoring period) from a predetermined time point of monitoring start as graphs where the axis of ordinates is set to the accumulated use time and the axis of abscissas is set to the elapsed time. For example, the time point of monitoring start is the time point of the user of the vehicle 100 purchasing the vehicle 100 to start the use of the vehicle 100.

In the graphs of FIG. 6, in the case of a user (heavy user or the like) high in use frequency of the vehicle 100, the inclination of the straight line is large as exemplarily indicated by L1. On the other hand, in the case of a user (casual user or the like) low in use frequency of the vehicle 100, the inclination of the straight line is small as exemplarily indicated by L2.

Here, when the inclination of the straight line is larger than that of a determination line Lj, it is inferred that the vehicle 100 is frequently used, charge of the battery 35 by the generator 34 is appropriately performed, and decrease of the power storage amount of the battery 35 during the period when the vehicle 100 is not being used is small. Therefore, by not performing initial charge of the battery 35 (Initial Charge Off), overcharge of the battery 35 can be restrained.

On the other hand, when the inclination of the straight line is smaller than that of the determination line Lj, it is inferred that intervals of use of the vehicle 100 become long, and decrease of the power storage amount of the battery 35 during the period when the vehicle 100 is not being used is large. Therefore, in this case, by performing initial charge of the battery 35, overcharge of the battery 35 can be restrained to perform appropriate initial charge.

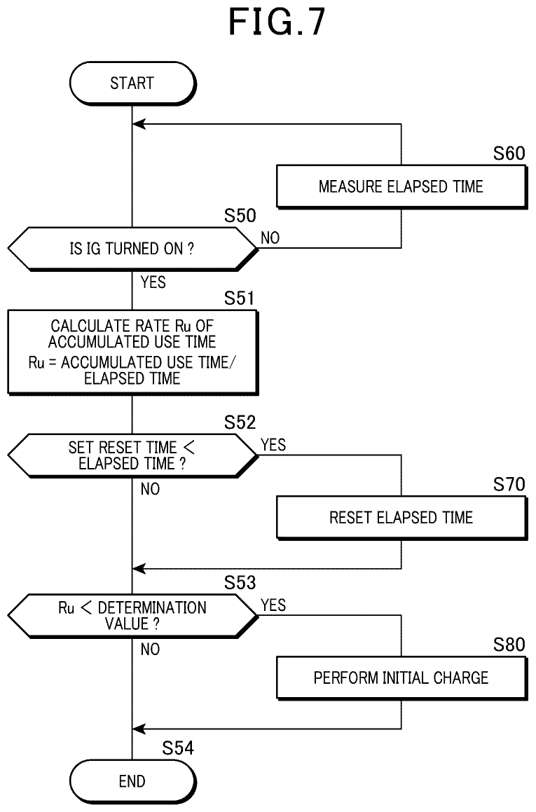

Next, FIG. 7 is a flowchart for performing processing of periodically resetting the elapsed period (monitoring period) mentioned above with reference to FIG. 6. Here, the contents of the processing are described, supposing that the ECU 1 performs the processing according to the flowchart shown in FIG. 7. By periodically resetting the monitoring period, the initial charge amount can be appropriately set in response to the case where the use frequency of the vehicle 100 by the user of the vehicle 100 changes or the similar case.

The ECU 1 continues measurement of the elapsed time in step S60 until recognizing the ON-operation of the IG switch 40 in step S50 of FIG. 7 when the vehicle 100 is not used, and puts the process forward to step S51 when recognizing the ON-operation of the IG switch 40. In step S51, the ECU 1 calculates a rate Ru of the accumulated use time based on equation (2) below. The accumulated use time is an accumulated use time of the vehicle 100 or an accumulated use time of the engine 30 during the elapsed time.

Ru=accumulated use time/elapsed time (2)

Subsequently in step S52, the ECU 1 determines whether or not the elapsed time exceeds a set reset time. For example, the set reset time is set to 240 hours (10 days). Then, when the elapsed time exceeds the set reset time, the ECU 1 puts the process forward to step S70 to reset the elapsed time and to put the process forward to step S53. On the other hand, when the elapsed time is not more than the set reset time, the ECU 1 puts the process forward to step S53, and in this case, the elapsed time is not reset.

In step S53, the ECU 1 determines whether or not the rate Ru of the accumulated use time is less than a determination value. Then, when the rate Ru of the accumulated use time is less than the determination value, the ECU 1 puts the process forward to step S80 to perform initial charge of the battery 35 and to put the process forward to step S54. Thereby, when since the rate Ru of the accumulated use time is low, it is inferred that the time when the vehicle 100 is not being used is long and the decrease of the power storage amount of the battery 35 is large, the charge amount of the battery 35 can be recovered.

On the other hand, when the rate Ru of the accumulated use time is not less than the determination value, the ECU 1 puts the process forward to step S54, and in this case, initial charge of the battery 35 is not performed. Thereby, when it is inferred that the use time of the vehicle 100 during the elapsed time is long and the decrease of the power storage amount of the battery 35 during the time when the vehicle 100 is not being used is small, initial charge of the battery 35 is not performed, and overcharge of the battery 35 can be restrained.

### 5. Configurations Supported by the Embodiment

The aforementioned embodiment is a specific example of configurations below.

(Configuration 1) A charge control apparatus that is mounted on a vehicle, the vehicle having an engine, a generator driven by the engine, and a secondary battery that is charged by the generator, the charge control apparatus controlling charge of the secondary battery by the generator, the charge control apparatus including: an engine operation time measurement unit that measures an operation time of the engine during a use period from use start to use end of the vehicle; an initial charge amount setting unit that sets an initial charge amount based on a previous engine operation time, the initial charge amount being for supplementing, in use start of the vehicle, an amount of decrease of a power storage amount of the secondary battery from previous use end of the vehicle, the previous engine operation time being an operation time of the engine measured by the engine operation time measurement unit during a previous use period of the vehicle; and a charge control unit that performs initial charge control of charging the secondary battery by the initial charge amount in use start of the vehicle.

According to the charge control apparatus of Configuration 1, the charge amount of the secondary battery in use start of the vehicle can be appropriately set, and deterioration of the secondary battery due to overcharge can be restrained.

(Configuration 2) The charge control apparatus according to Configuration 1, wherein the initial charge amount setting unit decreases the initial charge amount more as the previous engine operation time is longer.

According to the charge control apparatus of Configuration 2, it is inferred that, as the previous engine operation time is longer, the charge amount of the secondary battery by operation of the generator during the previous use period of the vehicle is larger. Therefore, by more decreasing the initial charge amount as the previous engine operation time is longer, overcharge of the secondary battery can be restrained.

(Configuration 3) The charge control apparatus according to Configuration 2, wherein the initial charge amount setting unit sets the initial charge amount to a first initial charge amount when the previous engine operation time is shorter than a first threshold, and sets the initial charge amount to a second initial charge amount smaller than the first initial charge amount when the previous engine operation time is not less than a second threshold longer than the first threshold.

According to the charge control apparatus of Configuration 3, by setting the initial charge amount to the first initial charge amount when the previous engine operation time is short, and sets the initial charge amount to the second initial charge amount smaller than the first initial charge amount when the previous engine operation time is not less than the second threshold longer than the first threshold, overcharge of the secondary battery can be restrained.

(Configuration 4) The charge control apparatus according to Configuration 3, wherein when the previous engine operation time is between the first threshold and the second threshold, the initial charge amount setting unit gradually decreases the initial charge amount from the first initial charge amount to the second initial charge amount as the previous engine operation time becomes longer.

According to the charge control apparatus of Configuration 4, the initial charge amount can be more appropriately set in accordance with the length of the previous engine operation time.

(Configuration 5) The charge control apparatus according to any one configuration of Configuration 1 to Configuration 4, including a secondary battery temperature recognition unit that recognizes a temperature of the secondary battery, wherein the initial charge amount setting unit sets the initial charge amount in accordance with the temperature, of the secondary battery, that is recognized by the secondary battery temperature recognition unit when use of the vehicle is started.

According to the charge control apparatus of Configuration 5, the initial charge amount can be set in consideration of the temperature, of the secondary battery, that affects an amount of self-discharge of the secondary battery.

(Configuration 6) The charge control apparatus according to any one configuration of Configuration 1 to Configuration 5, wherein the charge control unit forcibly ends the initial charge control when the initial charge control is not completed until a predetermined time elapses from start of the initial charge control.

According to the charge control apparatus of Configuration 6, by providing an upper limit on the charge time when charging the secondary battery by the initial charge amount, overcharge of the secondary battery can be restrained to restrain deterioration of the secondary battery.

(Configuration 7) The charge control apparatus according to Configuration 6, wherein the predetermined time is a fixed time regardless of the previous engine operation time.

According to the charge control apparatus of Configuration 7, by setting the upper limit of the charge time to the fixed time, processing of restraining overcharge of the secondary battery can be simplified.

(Configuration 8) A charge control method performed by a charge control apparatus that is mounted on a vehicle, the vehicle having an engine, a generator driven by the engine, and a secondary battery that is charged by the generator, the charge control apparatus controlling charge of the secondary battery by the generator, the charge control method including: an engine operation time measurement step of measuring an operation time of the engine during a period from use start to use end of the vehicle; an initial charge amount setting step of setting an initial charge amount based on a previous engine operation time, the initial charge amount being for supplementing, in use start of the vehicle, an amount of decrease of a power storage amount of the secondary battery from a previous use end time point of the vehicle, the previous engine operation time being an operation time of the engine measured by the engine operation time measurement step during a previous use period of the vehicle; and a charge control step of performing initial charge control of charging the secondary battery by the initial charge amount in use start of the vehicle.

By performing the charge control method of Configuration 8 with the charge control apparatus, the similar effects to those of the charge control apparatus of Configuration 1 can be obtained.

### REFERENCE SIGNS LIST

1 ECU (charge control apparatus)
10 processor
11 engine operation time measurement unit
12 initial charge amount setting unit
13 secondary battery temperature recognition unit
14 charge control unit
20 memory
21 program
22 initial charge amount setting data
30 engine
34 generator
35 battery
40 IG switch
50 charging current sensor
51 temperature sensor
52 voltage sensor
53 output current sensor
60 load

1. A charge control apparatus that is mounted on a vehicle, the vehicle having an engine, a generator driven by the engine, and a secondary battery that is charged by the generator, the charge control apparatus controlling charge of the secondary battery by the generator, the charge control apparatus comprising:
an engine operation time measurement unit that measures an operation time of the engine during a use period from use start to use end of the vehicle;
an initial charge amount setting unit that sets an initial charge amount based on a previous engine operation time, the initial charge amount being for supplementing, in use start of the vehicle, an amount of decrease of a power storage amount of the secondary battery from previous use end of the vehicle, the previous engine operation time being an operation time of the engine measured by the engine operation time measurement unit during a previous use period of the vehicle; and
a charge control unit that performs initial charge control of charging the secondary battery by the initial charge amount in use start of the vehicle.

2. The charge control apparatus according to claim 1, wherein the initial charge amount setting unit decreases the initial charge amount more as the previous engine operation time is longer.

3. The charge control apparatus according to claim 2, wherein the initial charge amount setting unit sets the initial charge amount to a first initial charge amount when the previous engine operation time is shorter than a first threshold, and sets the initial charge amount to a second initial charge amount smaller than the first initial charge amount when the previous engine operation time is not less than a second threshold longer than the first threshold.

4. The charge control apparatus according to claim 3, wherein when the previous engine operation time is between the first threshold and the second threshold, the initial charge amount setting unit gradually decreases the initial charge amount from the first initial charge amount to the second initial charge amount as the previous engine operation time becomes longer.

5. The charge control apparatus according to claim 1, comprising
a secondary battery temperature recognition unit that recognizes a temperature of the secondary battery, wherein
the initial charge amount setting unit sets the initial charge amount in accordance with the temperature, of the secondary battery, that is recognized by the secondary battery temperature recognition unit when use of the vehicle is started.

6. The charge control apparatus according to claim 1, wherein the charge control unit forcibly ends the initial charge control when the initial charge control is not completed until a predetermined time elapses from start of the initial charge control.

7. The charge control apparatus according to claim 6, wherein the predetermined time is a fixed time regardless of the previous engine operation time.

8. A charge control method performed by a charge control apparatus that is mounted on a vehicle, the vehicle having an engine, a generator driven by the engine, and a secondary battery that is charged by the generator, the charge control apparatus controlling charge of the secondary battery by the generator, the charge control method comprising:
an engine operation time measurement step of measuring an operation time of the engine during a period from use start to use end of the vehicle;
an initial charge amount setting step of setting an initial charge amount based on a previous engine operation time, the initial charge amount being for supplementing, in use start of the vehicle, an amount of decrease of a power storage amount of the secondary battery from a previous use end time point of the vehicle, the previous engine operation time being an operation time of the engine measured by the engine operation time measurement step during a previous use period of the vehicle; and
a charge control step of performing initial charge control of charging the secondary battery by the initial charge amount in use start of the vehicle.
